(19) United States
(12) Patent Application Publication
(10) Pub. No.: US 2015/0178164 A1
(43) Pub. Date: Jun. 25, 2015

(54) RECONSTRUCTING AN INDIRECTION TABLE FROM LOGGED MEDIA ADDRESSES

(71) Applicant: Violin Memory Inc., Santa Clara, CA (US)

(72) Inventor: Silei Zhang, Santa Clara, CA (US)

(73) Assignee: Violin Memory Inc., Santa Clara, CA (US)

(21) Appl. No.: 14/135,105

(22) Filed: Dec. 19, 2013

(51) Int. Cl. G06F 11/14

(52) U.S. Cl. CPC G06F 11/1435; G06F 11/1451

(57) ABSTRACT

The storage system uses a combination of checkpoint data and journal data to reconstruct an indirection table. The checkpoint data comprises compacted media addresses from the indirection table that are then stored in a relatively few number of media blocks. This allows the media controller to quickly read the compacted checkpoint data from the solid state media. The media controller generates the journal data from logical addresses and associated media addresses for additional write operations received while creating the checkpoint data. The media controller uses metadata when errors are identified in the checkpoint data or journal data.

The present application is a continuation-in-part of co-pending U.S. patent application Ser. No. 14/089,113; entitled: Method and Apparatus for Reconstructing An Indirection Table; filed Nov. 25, 2013, which is herein incorporated by reference in its entirety.

### BACKGROUND

A solid state device (SSD) may contain non-volatile memory, such as Flash memory. The SSD also may contain a controller that uses volatile memory to manage data storage in the Flash memory. For example, the SSD may store an indirection table in dynamic random access memory (DRAM). The controller tries to minimize memory usage, reduce latency, reduce storage errors, etc.

Cost constraints may limit the complexity of the controller such that costs are driven more by the number of Flash chips and less by the controller and DRAM. However, reduced amounts of DRAM may restrict overall SSD performance. For example, less DRAM may limit how quickly the controller can access Flash memory and thus increase overall storage latency. Additionally, the quantity of DRAM may impact the performance of management functions required of the controller.

### BRIEF DESCRIPTION OF THE DRAWINGS

FIG. 1 depicts an example storage system.

FIG. 2 depicts an example media controller.

FIG. 3 depicts a memory context structure used in solid state media.

FIG. 4 depicts an example indirection table used in the storage system.

FIG. 5 depicts an example metadata summary.

FIG. 6 depicts example checkpoint data.

FIG. 7 depicts example indirection data.

FIG. 8 depicts an example media block containing journal data.

FIG. 9 depicts example journal data.

FIG. 10 depicts an example process for reconstructing an indirection table.

FIG. 11 depicts example checkpoint data for an indirection table.

FIG. 12 depicts example journal data captured while storing the checkpoint data.

FIG. 13 depicts an example indirection table reconstructed from checkpoint data and journal data.

### DETAILED DESCRIPTION

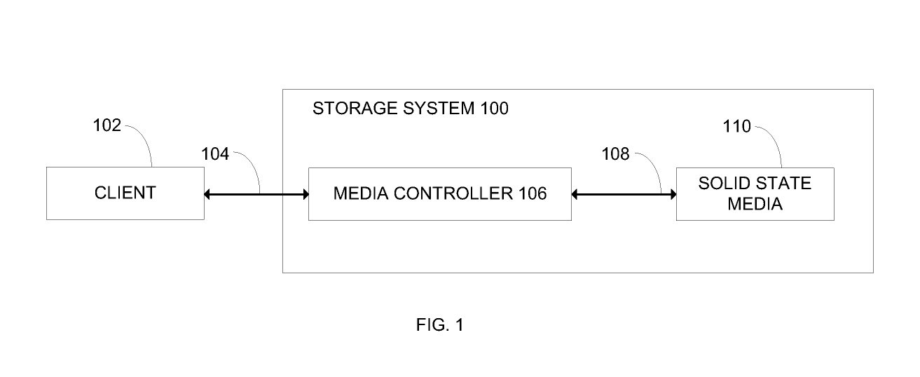

FIG. 1 shows a storage system 100 connected to a client 102. Storage system 100 may include a media controller 106 deployed between client 102 and solid state media 110. Client 102 may be any device or application that writes and/or reads data to and from another device. For example, client 102 may comprise one or more servers, server applications, database applications, routers, switches, client computers, personal computers (PCs), Personal Digital Assistants (PDA), smart phones, digital tablets, digital notebooks, or any other wired or wireless computing device and/or software that accesses data in solid state media 110.

In another example, client 102 may comprise a stand-alone appliance, device, or blade, and solid state media 110 may comprise a stand-alone storage array. In another example, client 102 may be a processor or software application in a personal computer or server that accesses solid state media 110 over an internal or external data bus. In a further example, client 102 may be a gateway or proxy device providing access to storage system 100 to one or more stand-alone appliances, devices or electronic entities. Access may be provided by cabled connections, wireless connections, or other means of communication with client 102.

Solid state media (SSM) 110 may comprise any device that stores data accessed by another device, application, software, client, or the like, or any combination thereof. For example, SSM 110 may comprise one or more solid state device (SSD) chips or dies that contain one or more flash memories. In another example, SSM 110 may comprise storage disks, rotating disk devices, integrated memory devices, or the like, or any combination thereof. SSM 110 may exist locally within the same physical enclosure as media controller 106 and/or client 102 or may exist externally in a chassis connected to client 102 and/or media controller 106.

Client 102, media controller 106, and/or solid state media 110 may be directly connected together, or connected to each other through a network or fabric. In one example, client 102, media controller 106, and/or solid state media 110 are coupled to each other via wired or wireless connections.

Different communication protocols can be used over connection 104 between client 102 and media controller 106, and connection 108 between media controller 106 and SSM 110. Example protocols may include Fibre Channel Protocol (FCP), Small Computer System Interface (SCSI), Advanced Technology Attachment (ATA) and encapsulated protocols such as Fibre Channel over Ethernet (FCoE), Internet Small Computer System Interface (ISCSI), Fibre Channel over Internet Protocol (FCIP), ATA over Ethernet (AoE), Internet protocols, Ethernet protocols, or the like, or any combination for layering thereof.

Protocols used between client 102 and storage system 100 also may include tunneled or encapsulated protocols that allow communication over multiple physical interfaces such as wired and wireless interfaces. Connections 104 and 108 may use the same protocols or different protocols.

Media controller 106 receives read and write commands from client 102. The write and read commands may include associated storage addresses, alternatively referred to as logical addresses. Media controller 106 writes or reads data associated with the logical addresses to and from SSM 110. Media controller 106 maps the logical addresses from client 102 to physical address locations within SSM 110. Media controller 106 may include an indirection table that stores the address mappings between the logical addresses received from client 102 and the physical addresses in SSM 110.

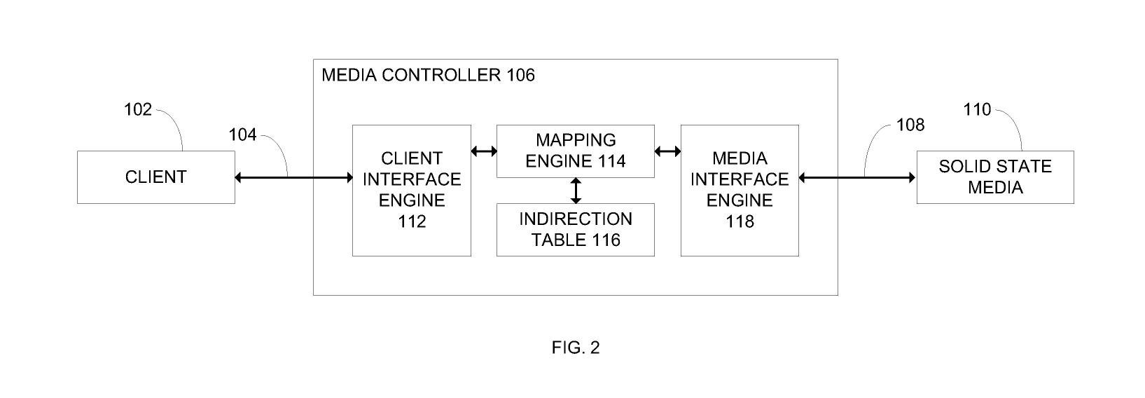

FIG. 2 depicts an example of media controller 106. Media controller 106 may be any device that abstracts a logical address from client 102 to a physical address on SSM 110. Client interface engine 112 receives read and write operations from client 102 over connection 104. Mapping engine 114 maps logical addresses for the read and write operations to media addresses within SSM 110. Logical addresses are alternatively referred to as virtual addresses or client addresses and media addresses within SSM 110 are alternatively referred to as physical addresses.

Mapping engine 114 may receive a read operation from client 102 that includes a logical address. Mapping engine 114 maps the logical address to a corresponding address location in indirection table 116. The identified address location in the indirection table contains a media address. Mapping engine 114 sends the media address to media interface engine 118. Media interface engine 118 accesses data in SSM 110 associated with the identified media address.

In one example, media controller 106 may store indirection table 116 in volatile DRAM that needs power to maintain stored information. When media controller 106 is powered off and then powered back on, mapping engine 114 may need to reconstruct indirection table 116 with the mappings between the logical addresses used by client 102 and the media addresses used by SSM 110.

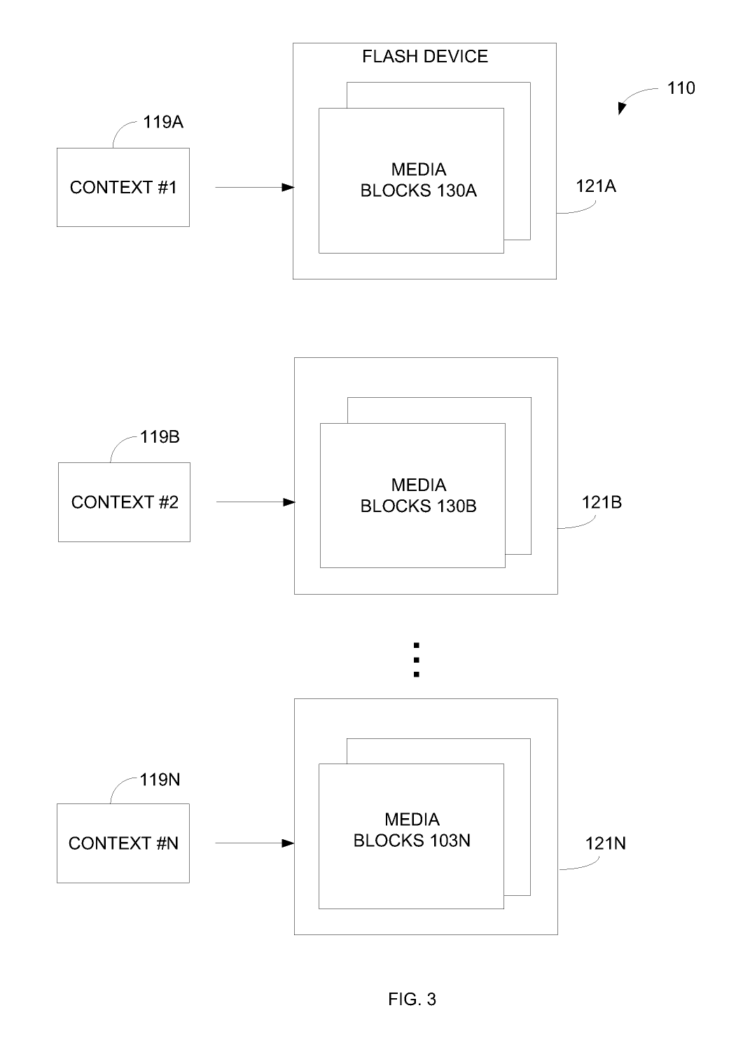

FIG. 3 depicts an example hierarchical flash memory structure within SSM 110. SSM 110 may consist of one or more Flash devices 121 each including multiple planes. Each plane may include a separate interface for connecting to media controller 106. Each plane also may include multiple media blocks 130. In one example, each media block 130 constitutes the smallest erasable portion of memory within Flash device 212. Example sizes of media blocks 130 may comprise 4, 8, or 16 megabytes (MBs).

Each media block 130 may comprise 256 pages each being 8 thousand bytes (8 KBs) or 16 KBs. The media controller might erase 4, 8, and/or 16 MB blocks 130 but may only be able to write to 8 or 16 KB pages. Read operations may span a page, groups of consecutive pages, or portions of a page. Of course these are just examples and media blocks 130, pages, reads, and writes may be any size.

Contexts 119 may be any combination of software and hardware that separately access Flash devices or dies 121 within SSM 110. Contexts 119 may access different flash devices or dies 121 to increase the speed of write and read operations in SSM 110. For example, a first context 119A may access a first set of media blocks 130A for a first set of Flash devices or dies 121A. A second context 119B may separately access a second set of media blocks 130B for a second set of Flash devices or dies 121B within SSM 110, etc. The purpose of contexts 119 is to assure allocated resources within media controller 106 are available to exploit the parallelism available by the multiple dies or packages of solid state media. Performance is generally optimized when a maximum number of concurrent operations can be performed by media controller 106.

Each context 119 may access some number of non-volatile Flash devices 121. For example, each context 119 may manage media blocks 130 and pages within eight different Flash devices 121 and use any of the eight Flash devices 121 for storing data. Of course, this is just one example and any number and type of memory devices and memory sizes may be accessed by any number of contexts 119.

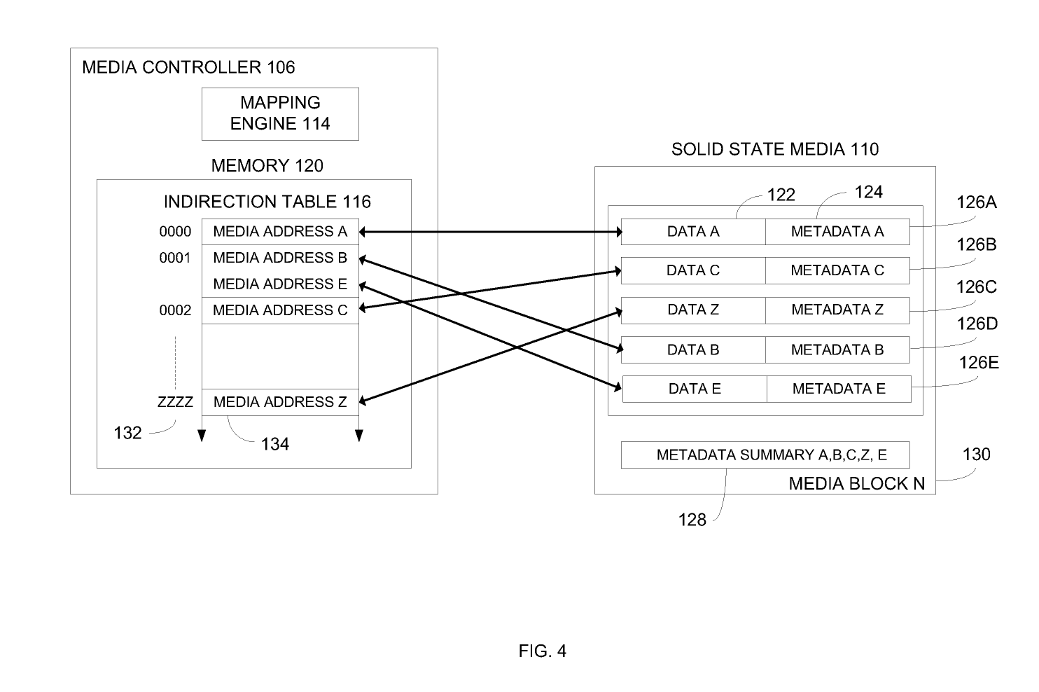

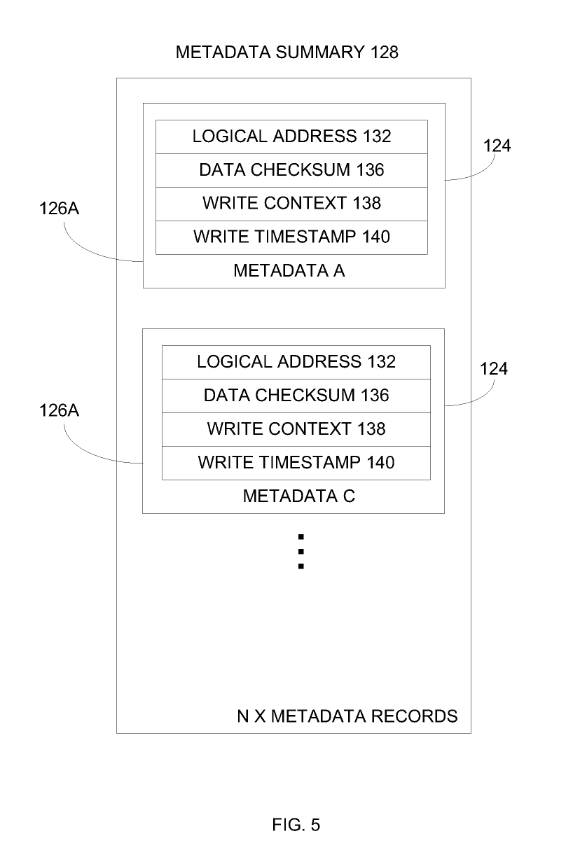

Referring to FIGS. 4 and 5, logical addresses 132 represent addresses received from client 102 in FIG. 1 and may have corresponding addresses within volatile memory 120. For example, each logical address 132 may correspond to a particular address offset in memory 120. Media addresses 134 represent physical addresses within SSM 110 that contain data associated with logical addresses 132. In one example, each media address 134 may correspond to a 1 KB sub-block of data within a particular media block 130 of SSM 110. These sub-blocks of data are alternatively referred to as lines 126.

Each 1 KB line 126 of SSM 110 may contain media or data 122 and metadata 124. For example, metadata 124 in lines 126 may include a logical address 132, a data checksum 136, a write context 138, and a write timestamp 140.

As mentioned above, memory 120 may comprise volatile DRAM that loses information during a power off or reset condition. Logical addresses 132 in metadata 124 may be stored in non-volatile Flash devices within SSM 110 and are retained during the power off or reset condition. After the storage system is powered back on, media controller 106 uses metadata 124 in SSM 110 to reconstruct indirection table 116 in volatile memory 120.

For example, metadata A in line 126A may contain logical address 0000. After a power up, mapping engine 114 may store the media address A for line 126A into address location 0000 of indirection table 116.

Media controller 106 may use data checksums 136 to correct errors in associated data 122. For example, data checksums 136 may comprise a 24, 32, or 40 bit error-correcting codes (ECC), such as a BCH code. In one example, data checksums 136 may represent fields of data which may be populated by arbitrary error-correcting codes rather than an exclusive physical checksum operation as known to those skilled in the art of logic design. In another example, error correcting codes operate iteratively by attempting to reread data 122 using alternate commands to SSM 110.

As also explained above, different contexts may write in parallel to different blocks or pages in SSM 110. For example, client 102 in FIG. 1 may write different data to the same logical address multiple times. The writes may be written by the different contexts to different Flash devices. Metadata 124 contains context identifiers 138 that identify which contexts wrote the data into SSM 110.

Media controller 106 may receive a read request having logical address 0001. Mapping engine 114 accesses indirection table 116 and identifies associated media address B. Mapping engine 114 reads data B and metadata B from line 126D and, if necessary, uses data checksum 136 in metadata B to correct data B. Mapping engine 114 also may confirm logical address 132 in metadata B points back to address 0001 of indirection table 116.

Media controller 106 may receive a write operation that writes data E to logical address 0001. Media controller 106 needs to overwrite data B in line 126D with new data E. However, media controller 106 may only erase data on a per block bases and only write data on a per page bases.

Data A, data C, data Z, and data B are stored in lines 126A-126D, respectively. Each line 126A-126D may only be 1 KB. Media controller 106 may need to wait for 8 or 16 additional lines of data before writing to an 8 KB or 16 KB page in SSM 110. Thus, media controller 106 cannot overwrite data B with data E in the 1 KB line 126D.

Instead, media controller 106 may write data E into a new line 126E in another page of the same or a different media block 130. Media controller 106 then may update logical address 0001 in indirection table 116 to point to media address E for line 126E. Now metadata B for line 126D and metadata E for line 126E both include logical address 0001.

Media controller 106 may use metadata 124 with the most recent write timestamp 140 to reconstruct indirection table 116. For example, when reconstructing indirection table 116, media controller 106 determines both metadata B and metadata E contain logical address 0001. Media controller 106 stores media address E in logical address 0001 of indirection table 116 since metadata E has a more recent write timestamp 140.

To increase performance, indirection table 116 may have a linear association with SSM 110. A linear indirection table 116 may need to be relatively large to store media addresses for all of lines 126 in a large SSM 110. For example, assume SSM 110 is one terabyte (TB) and lines 126 are 1 KB. Indirection table 116 would need space for one billion entries each holding a 32 bit media address 134. Therefore, indirection memory 120 would need 4 GBs to store one billion entries each holding a 32 bit address (4 bytes). It would also take a relatively long time for media controller 106 to read metadata 124 from every line 126 of SSM 110 and reconstruct indirection table 116.

To reduce reconstruction time, media controller 106 writes a metadata summary 128 at the end of each media block 130. Metadata summary 128 includes copies of all metadata 124 for all lines 126 of media block 130. For example, metadata summary 128 in FIG. 5 contains logical address 132, data checksum 136, write context 138, and write timestamp 140 for each line 126 in media block 130. Media controller 106 then only needs to read one page containing metadata summary 128 to obtain all of metadata 124 for media block 130.

One downside of metadata summary 128 is that media controller 106 may need to read at least a portion of each media block 130 in SSM 110 in order to restore indirection table 116. The system described below restores indirection table 116 more quickly by reading fewer media blocks 130. However, the media controller still may read metadata summary 128 as a backup for replacing corrupted data.

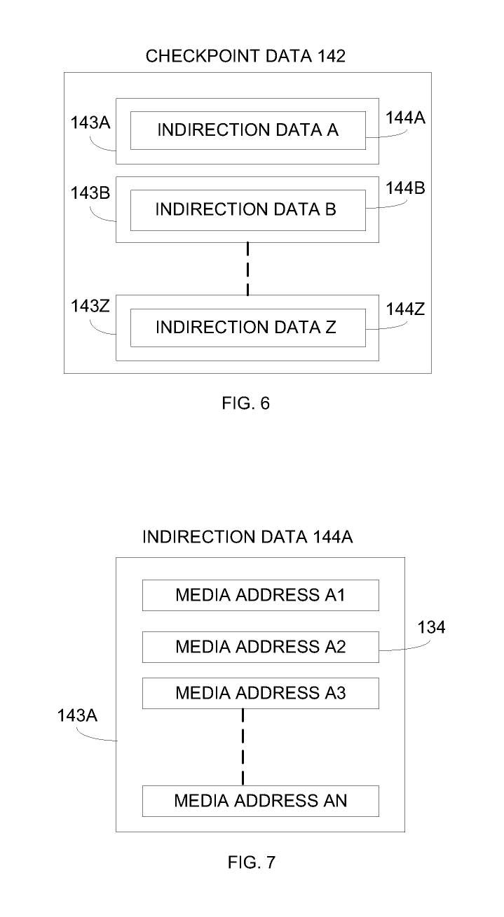

FIG. 6 shows checkpoint data 142 that consists of a logged memory dump of the indirection table. Checkpoint data 142 comprises blocks 143 of indirection data 144 containing different portions of indirection table 116. FIG. 7 shows example indirection data 144B that contains media addresses 134 for a sequential portion of the indirection table.

Referring to FIGS. 4, 6, and 7, media controller 106 stores indirection data A into a first page or block 143A of SSM 110. Indirection data A contains a first set of media addresses 134 for a first sequential set of logical addresses of indirection table 116. Media controller 106 then stores indirection data B into a second contiguous page or block 143B within SSM 110 containing a second set of media addresses 134 from a second sequential contiguous set of logical addresses of indirection table 116.

Indirection table 116 is linear where each logical address 132 maps to a different corresponding media address 134 in SSM 110. Media addresses 134 in indirection data 144 are stored in sequential contiguous pages or blocks in SSM 110. Thus, the position of media addresses 134 within indirection data 144 correspond to the logical addresses of indirection table 116. For example, the third media address A3 in indirection data 144A implicitly corresponds with logical address 0002 in indirection table 116 of FIG. 4. Therefore, media controller 106 does not need to store logical addresses 132 in indirection data 144 and checkpoint data 142 only contains a tightly packed group of media address 134.

In one example, SSM 110 may write data in 8 KB or 16 KB media blocks or pages. In this example, indirection data 144A, 144B . . . 144Z may comprise 8 KB or 16 KB pages or blocks 143 of media addresses 134. Checkpoint data 142 may log multiple contiguous 8 KB or 16 KB blocks 143 into one or more contiguous 4 MB, 8 MB, or 16 MB media blocks 130. Thus, an upper portion of a physical address for SSM 110 may reference particular page or block 143 of checkpoint data 142 and a lower portion of the physical address for SSM 110 may reference particular indirection data 144 corresponding to particular logical addresses of indirection table 116.

Media controller 106 may repeatedly generate new checkpoint data 142 containing the latest version of indirection table 116. For example, media controller 106 may copy media addresses 134 in indirection table 116 from a first address zero to a last address into SSM 110 as first checkpoint data 142. Media controller 106 may copy media addresses 134 for a next newer version of indirection table 116 into SSM 110 as second checkpoint data 142. Media controller 106 may maintain the first older checkpoint data 142 until the newer second version of checkpoint data 142 is created and successfully stored in SSM 110.

Media controller 106 may need to reconstruct indirection table 116 after the storage system is reset or powered-up. Media controller 106 can read the relatively few contiguous blocks 143 of indirection data 144 instead of reading small pieces of every media block 130 within SSM 110 containing metadata summaries 128.

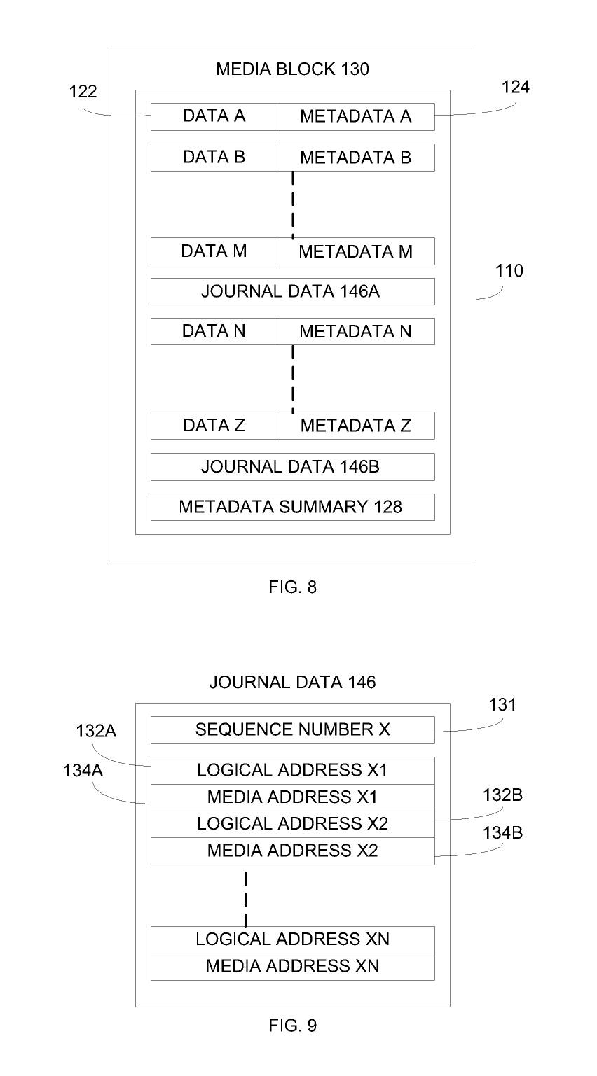

Referring to FIG. 8, some entries in indirection table 116 may change while or after checkpoint data 142 is stored in SSM 110. The media controller captures addition journal data 146 that contains the new media addresses added to indirection table 116. Media addresses in journal data 146 are then overlayed with the checkpoint data to reconstruct the indirection table.

Journal data 146A and 146B are inserted into media block 130 along with data 122 and metadata 124. Journal data 146B contains updates to indirection table 116 after journal data 146A is stored in SSM 110. For example, journal data 146A identifies all of the write operations since creation of checkpoint data 142 in FIG. 6 and journal data 146B identifies all of the write operations since creation of journal data 146A. The amount of journal data 146A and 146B may vary based on the rate of write operations to SSM 110.

Media controller 106 may temporarily store journal data 146 in a scratchpad portion of volatile memory 120 in FIG. 4 until some amount of data 122 is stored in SSM 110. For example, each media block 130 in SSM 110 may comprise 256 pages. The media controller may write journal data 146A into SSM 110 after 128 pages of data 122 are stored in media block 130. The media controller may write journal data 146B into SSM 100 at the end of media block 130 just before writing metadata summary 128.

In another example, media controller 106 may write journal data 146 into SSM 110 after accumulating some amount of logical and media addresses in the scratch pad.

For example, the media controller may store 8 KB or 16 KB pages of journal data 146 into SSM 110.

FIG. 9 shows information contained in journal data 146. Journal data 146 may include a sequence number 131 and pairs of logical addresses 132 and media addresses 134. Each logical address 132 and associated media address 134 indicates a changed media address in indirection table 116.

Media controller 106 overwrites media addresses 134 in checkpoint data 142 with media addresses from journal data 146. For example, first media address 134A in journal data 146 replaces the media address in checkpoint data 142 associated with logical address 132A. Second media address 134B in journal data 146 replaces the media address in checkpoint data 142 associated with logical address 132B, etc.

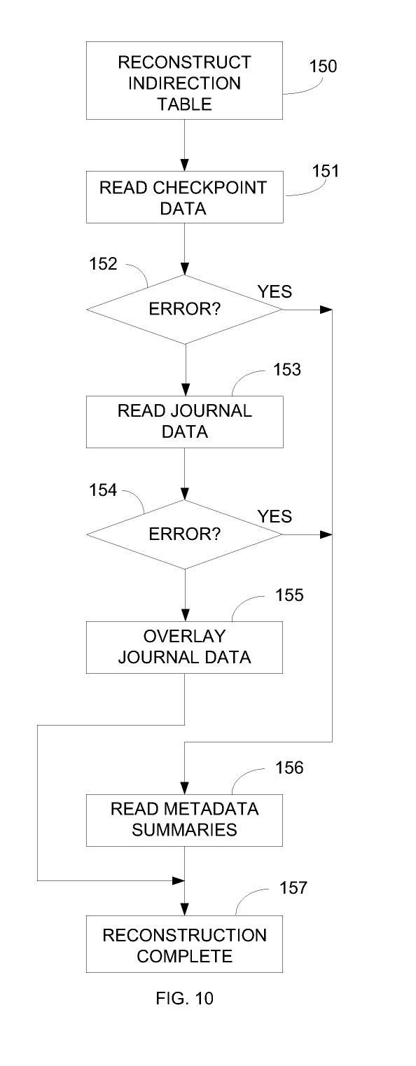

FIG. 10 depicts an example process for reconstructing the indirection table. In operation 150 the media controller detects a reconstruction condition. For example, the storage system may be powered up or reset. In operation 151 the media controller may read the checkpoint data previously stored in the SSM. For example, the media controller reads media blocks in the SSM containing media addresses arranged in an order associated with the sequential logical addresses of the indirection table.

In operation 152 the media controller detects any errors in the checkpoint data. For example, some of the checkpoint data may have been corrupted when written into SSM 100 and/or some of the checkpoint data may have been corrupted when read from SSM 100. If an error is detected in operation 152, the media controller in operation 156 may reconstruct the indirection table from the metadata summaries.

If no errors exist in the checkpoint data in operation 152, the media controller reads the journal data in operation 153. For example, the media controller may read the one or more pages of journal data that identify write operations received during and after the checksum was stored in the SSM.

In operation 154, the media controller checks for any errors in the journal data. The media controller also may detect missing journal data based on a missing associated sequence number 131 in FIG. 9. If journal data is corrupted or missing, the media controller may use the sequence numbers 131 to locate the associated media block and metadata summary.

If any errors exist in the journal data, the media controller in operation 156 reconstructs the indirection table from the metadata summaries. Otherwise, operation 155 overlays the journal data with the checkpoint data and reconstruction completes in operation 157.

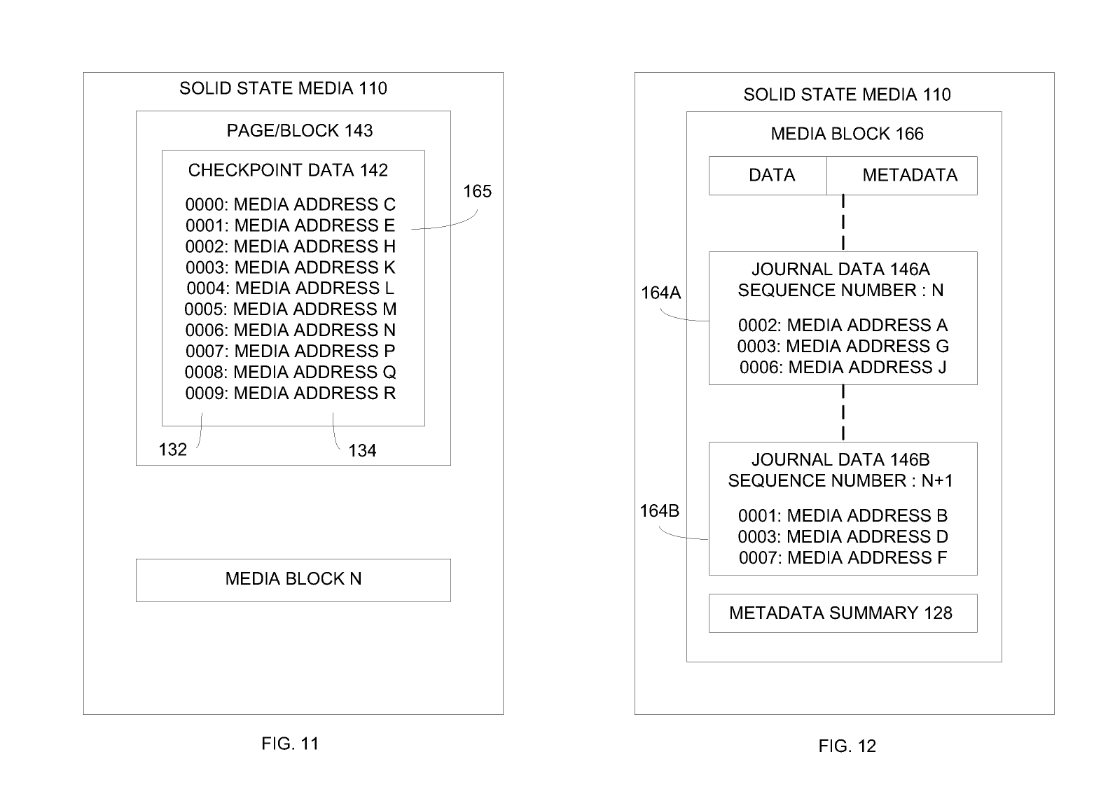

FIG. 11 shows example checkpoint data 142 copied from the indirection table and stored in SSM 110. In this example, the indirection table contained ten entries 165 that were copied by the media controller into a page or block 143 in SSM 110. Of course, the indirection table may contain any number of entries 165.

Only media addresses 134 are stored in checkpoint data 142 and logical addresses 132 are only shown for reference purposes. For example, a media address C is located in a first location of checkpoint data 142 indicating media address C was previously stored in address location 0000 of the indirection table. Media address E is located in a second position in checkpoint data 164 indicating media address E was previously stored in address location 0001 of the indirection table, etc.

FIG. 12 shows example journal data 146 generated by the media controller. As explained above, the media controller tracks each write operation received by the storage system during and after generating checkpoint data 142. Each new write operation may cause the media controller to store a new media address in one of the logical address locations of the indirection table. The media controller copies the logical address and the associated media address for the write operation into a scratch pad in volatile memory 120 of FIG. 4.

In the example of FIG. 12, data for logical address 0002 was stored into media address A, data for logical address 0003 was stored into media address G, and data for logical address 0006 was stored into media address J. The media controller stores the journal data 146A containing the logical addresses and associated media addresses into one or more lines, pages, or blocks 164A of media block 166.

While writing journal data 146A into media block 166, the media controller continues to track new write operations in the storage system. The media controller again copies the logical addresses and associated media addresses for the additional write operations into a scratch pad in memory 120.

The media controller generates journal data 146B for the next series of write operations. Journal data 146B identifies logical address 0001 for data stored in media address B, logical address 0003 for data stored in media address D, and logical address 0007 for data stored in media address F. The media controller writes journal data 146B into one or more lines, pages, and/or blocks 164B of media block 166.

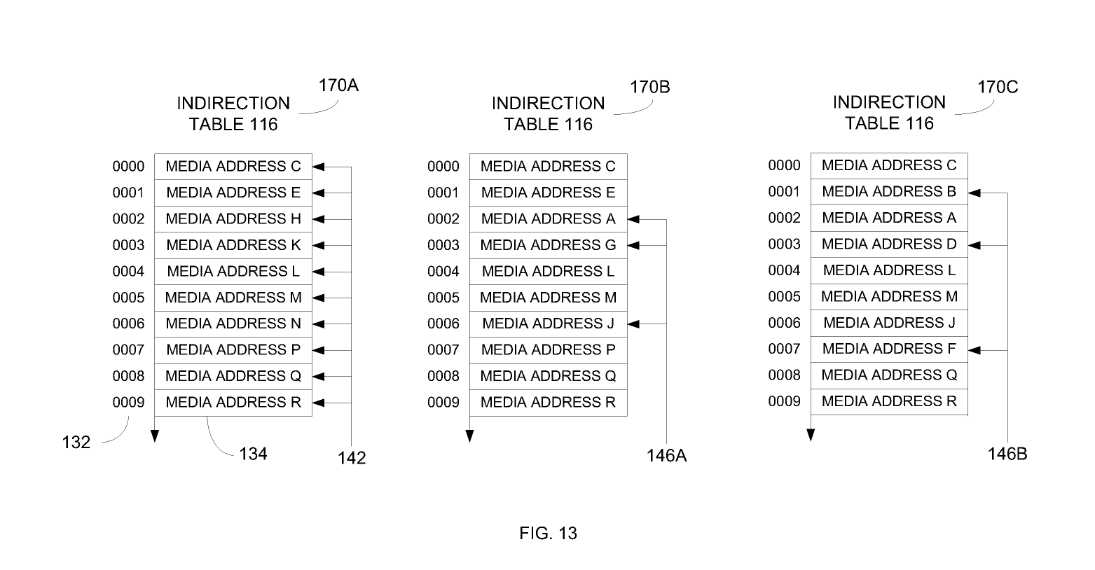

FIG. 13 shows the sequential reconstruction of indirection table 116 after a power-up, reset or some other reconstruction condition. The media controller generates a first indirection table state 170A from checkpoint data 142. For example, the media controller reads the media blocks in SSM 110 containing checkpoint data 164 into the memory 120 in FIG. 4.

The media controller generates a second indirection table state 170B from journal data 146A. Journal data 146A contains a next sequence number after creation of checkpoint data 142 and is therefore the first journal data applied to checkpoint data 142. In this example, media address A in journal data 146A replaces media address H at logical address 0002, media address G replaces media address K at logical address 0003, and media address J replaces media address N at logical address 0006.

Journal data 146B has a next sequence number after journal data 146A and is therefore the second journal data applied to indirection table 116. In this example, media address B in journal data 146B replaces media address E at logical address 0001, media address D replaces media address G at logical address 0003, and media address F replaces media address P at logical address 0007.

Thus, the storage system uses a combination of checkpoint data and journal data to reconstruct indirection table 116. The checkpoint data comprises compacted media addresses from the indirection table that are then stored in a relatively few number of media blocks. This allows the media controller to quickly read the compacted checkpoint data from the solid state media. The media controller generates the journal data from logical addresses and associated media addresses for additional write operations received while creating the checkpoint data. The media controller uses metadata when errors are identified in the checkpoint data or journal data.

### Hardware and Software

Several examples have been described above with reference to the accompanying drawings. Various other examples are also possible and practical. The systems and methodologies may be implemented or applied in many different forms and should not be construed as being limited to the examples set forth above. Some systems described above may use dedicated processor systems, micro controllers, programmable logic devices, or microprocessors that perform some or all of the operations. Some of the operations described above may be implemented in software or firmware and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

### Digital Processors, Software and Memory Nomenclature

As explained above, embodiments of this disclosure may be implemented in a digital computing system, for example a CPU or similar processor. More specifically, the term “digital computing system,” can mean any system that includes at least one digital processor and associated memory, wherein the digital processor can execute instructions or “code” stored in that memory. (The memory may store data as well.)

A digital processor includes but is not limited to a microprocessor, multi-core processor, Digital Signal Processor (DSP), Graphics Processing Unit (GPU), processor array, network processor, etc. A digital processor (or many of them) may be embedded into an integrated circuit. In other arrangements, one or more processors may be deployed on a circuit board (motherboard, daughter board, rack blade, etc.). Embodiments of the present disclosure may be variously implemented in a variety of systems such as those just mentioned and others that may be developed in the future. In a presently preferred embodiment, the disclosed methods may be implemented in software stored in memory, further defined below.

Digital memory, further explained below, may be integrated together with a processor, for example Random Access Memory (RAM) or FLASH memory embedded in an integrated circuit Central Processing Unit (CPU), network processor or the like. In other examples, the memory comprises a physically separate device, such as an external disk drive, storage array, or portable FLASH device. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such a conventional rotating disk drive. All such memories are “machine readable” in that they are readable by a compatible digital processor. Many interfaces and protocols for data transfers (data here includes software) between processors and memory are well known, standardized and documented elsewhere, so they are not enumerated here.

### Storage of Computer Programs

As noted, some embodiments may be implemented or embodied in computer software (also known as a “computer program” or “code”; we use these terms interchangeably). Programs, or code, are most useful when stored in a digital memory that can be read by one or more digital processors. The term “computer-readable storage medium” (or alternatively, “machine-readable storage medium”) includes all of the foregoing types of memory, as well as new technologies that may arise in the future, as long as they are capable of storing digital information in the nature of a computer program or other data, at least temporarily, in such a manner that the stored information can be “read” by an appropriate digital processor. The term “computer-readable” is not intended to limit the phrase to the historical usage of “computer” to imply a complete mainframe, mini-computer, desktop or even laptop computer. Rather, the term refers to a storage medium readable by a digital processor or any digital computing system as broadly defined above. Such media may be any available media that is locally and/or remotely accessible by a computer or processor, and it includes both volatile and non-volatile media, removable and non-removable media, embedded or discrete.

Having described and illustrated a particular example system, it should be apparent that other systems may be modified in arrangement and detail without departing from the principles described above. Claim is made to all modifications and variations coming within the spirit and scope of the following claims.

1. An apparatus, comprising:
checkpoint data for an indirection table, wherein the checkpoint data is stored in a solid state media and comprises media addresses for sequential logical addresses of the indirection table;
journal data stored in the solid state media, wherein the journal data identifies changes in the indirection table after creation of the checkpoint data;
metadata summaries stored in the solid state media, wherein the metadata summaries contain error correction data for the checkpoint data and journal data; and
logic circuitry configured to:
read the checkpoint data from the solid state media;
read the journal data from the solid state media;
reconstruct the indirection table by overwriting at least some of the media addresses from the checkpoint data with media addresses from the journal data;
check for errors in the checkpoint data or the journal data; and
use the metadata summaries to recover from the errors in the checkpoint data and/or the errors in the journal data.

2. The apparatus of claim 1, wherein the indirection table comprises a linear association of the logical addresses of the indirection table with the media addresses of the solid state media.

3. The apparatus of claim 1, wherein the journal data comprises the logical addresses and associated media addresses for write operations performed after creation of the checkpoint data.

4. The apparatus of claim 1, wherein the metadata summaries contain the error correction data for blocks of sequential media address locations in the solid state memory.

5. The apparatus of claim 1, wherein the logic circuitry is further configured to:
identify locations in the solid state media associated with the errors in the checkpoint data or the errors in the journal data;
identify locations in the metadata summaries associated with the locations in the solid state media associated with the errors; and
use the error correction data at the identified locations in the metadata summaries to reconstruct the indirection table.

6. The apparatus of claim 1, wherein the checkpoint data is stored in sequential address locations in the solid state media and the error correction data is stored in locations of the metadata summaries corresponding to the sequential address locations of the checkpoint data.

7. The apparatus of claim 1, wherein the journal data is stored in sequential address locations in the solid state memory corresponding to sequential changes to the indirection table and the error correction data for the journal data is stored in locations of the metadata summaries corresponding to the sequential address locations of the journal data.

8. The apparatus of claim 1, wherein the logic circuitry is configured to overwrite the media addresses from the checkpoint data with the media addresses from the journal data in an order based on time stamps associated with the journal data.

9. The apparatus of claim 1, wherein:
the indirection table is stored in volatile memory;
the checkpoint data is stored in non-volatile solid state memory; and
the logic circuitry is configured to reconstruct in the indirection table in the volatile memory from the checkpoint data and the journal stored in the non-volatile memory in response to a power-up or reset condition.

10. A method, comprising:
identifying a reconstruction condition for an indirection table;
reading checkpoint data for the indirection table from a memory, wherein the checkpoint data comprises media addresses for sequential logical addresses of the indirection table;
reading journal data from the memory, wherein the journal data identifies changes between different stored versions of the checkpoint data;
reconstructing the indirection table by overwriting at least some of the media addresses from the checkpoint data with media addresses from the journal data;
checking for errors in the checkpoint data or the journal data;
identifying metadata summaries in the memory containing error correction data for the checkpoint data and/or journal data; and
using the error correction data in the metadata summaries to recover from the errors in the checkpoint data and/or the errors in the journal data.

11. The method of claim 10, wherein the different versions of the checkpoint data are periodically generated from different states of the indirection table and the journal data comprises the logical addresses and associated media addresses for write operations received between the different versions of the checkpoint data.

12. The method of claim 10, wherein the metadata summaries contain the error correction data for blocks of data stored in sequential address locations of the memory.

13. The method of claim 10, further comprising:
identifying address locations in the memory associated with the errors in the checkpoint data and/or the errors in the journal data;
identifying locations in the metadata summaries associated with the address locations in the memory associated with the errors; and
using the error correction data at the identified locations in the metadata summaries to reconstruct the indirection table.

14. The method of claim 10, wherein the checkpoint data is stored in sequential address locations in the memory and some of the error correction data is stored in locations of the metadata summaries corresponding to the sequential address locations of the checkpoint data.

15. The method of claim 10, wherein the journal data is stored in sequential address locations in the memory corresponding to sequential changes to the media addresses in the indirection table and the error correction data for the journal data are stored in locations of the metadata summaries corresponding to the sequential address locations of the of the journal data.

16. The method of claim 10, further comprising reconstructing the indirection table by overwriting the media addresses from the checkpoint data with the media addresses from the journal data in an order based on time stamps associated with the journal data.

17. The method of claim 10, wherein the checkpoint data and journal data are stored in non-volatile memory, and further comprising reconstructing the indirection table in volatile memory from the checkpoint data and the journal stored in the non-volatile memory in response to a power-up or reset condition.

18. An apparatus, comprising:
non-volatile memory configured to store checkpoint data for an indirection table, journal data containing changes in the checkpoint data, and metadata summaries containing error correction data for the checkpoint data and journal data; and
a media controller configured to:
read the checkpoint data and the journal data from the non-volatile memory into a volatile memory;
reconstruct the indirection table by updating at least some of the checkpoint data with the journal data; and
use the metadata summaries to recover from errors in the checkpoint data and/or errors in the journal data.

19. The apparatus of claim 18, wherein the indirection table comprises a linear association of logical addresses with media addresses in the non-volatile memory.

20. The apparatus of claim 18, wherein the metadata summaries contain error correction data for blocks of data stored in sequential address locations of the non-volatile memory.

21. The apparatus of claim 18, wherein the media controller is further configured to:
identify locations in the non-volatile memory associated with the errors in the checkpoint data and/or the errors in the journal data;
identify locations of the error correction data in the metadata summaries associated with the locations in the non-volatile memory associated with the errors; and
use the error correction data at the identified positions in the metadata summaries to reconstruct the indirection table.

22. The apparatus of claim 18, wherein the checkpoint data is stored in sequential address locations of the non-volatile memory and some of the error correction data is stored in locations of the metadata summaries corresponding to the sequential address locations of the checkpoint data.

23. The apparatus of claim 18, wherein the journal data is stored in sequential address locations of the non-volatile memory corresponding to sequential changes to the media addresses in the indirection table and the error correction data is stored in positions of the metadata summaries corresponding to the sequential address locations of the journal data.
